(19) United States
(12) Patent Application Publication
(10) Pub. No.: US 2007/0071421 A1
(43) Pub. Date: Mar. 29, 2007

(54) Digital permanent magnet electric motor

(76) Inventor: Donald Frank Vaccarino, Willoughby, OH (US)

Correspondence Address: Donald Frank Vaccarino, 38235 Cheltenham Drive, Willoughby, OH, 44094, US

(21) Appl. No.: 11/234,249

(22) Filed: Sep. 23, 2005

(51) Int. Cl. H02P 7/00

(52) U.S. Cl. 388/825

(57) ABSTRACT

The Digital permanent magnet electric motor's basic use is to power vehicles in an economical manner. Its low speed high torque eliminates costly high maintenance torque converters (transmissions) now in use. The design makes the controller more reliable than current motor controllers.

The logic behind this electric motor is the use of an array of rotating permanent magnets powered by individually pulsed Electro-magnets pushing and or pulling the magnet armature in a rotational motion.

The rotating permanent magnet array is structured such that both the north and south magnetic fields are used to provide rotary torque. Both fields of the Electro-magnets are utilized also.

A computer controlled alternating direct current pulse (sine wave) generator provides the digital control for this motor. The frequency and duration of the pulses control the rotational speed. The voltage and number of Electro-magnets activated control the power (torque).

Each Electro-magnet has it's own controller circuit. The direct current applied to the Electro-magnet is turned off as the permanent magnet nears it. The polarity of the voltage applied to the Electro-magnet is reversed after the rotating permanent magnet passes its center.

### BACKGROUND OF INVENTION

My original purpose in the development of this invention was to devise a practical motor controller for use in automobiles, electric tow motors and tractors or any device needing a powerful controllable electric motor. After beating my head against the brick wall I realized that conventional electric motors were the problem, not the controllers.

Being a computer service person I came up with the idea that the best way to control a device was to digitize it. The multiple Electro-magnets were much easier to control. The large permanent magnets make a perfect flywheel and provide a great amount of controllable low speed torque.

### SUMMARY OF INVENTION

The use of this electric motor can make possible simple, easily serviced transportation. A purely electric powered vehicle can be a gasoline powered generator for the power to begin with and easily moved to alternate fuels for the generator later on.

Today's hybrid electric cars are an overly complicated collection of old and new technologies providing only mild improvements in fuel economy. A true electric vehicle is the most efficient means of transportation, just as the current train is the best form of shipping. They have been electric for seventy-five years.

### DESCRIPTION OF DRAWINGS

The front view drawing is a cutaway view showing the motor cut in half. It plainly shows four of the eight permanent magnets in this smaller example. As you can see the permanent magnets are opposed in respect to polarity. The pairs of Electro-magnets are energized such that south pushes south and north pushes north. The next set of permanent magnets in the rotating array are opposite in polarity such that the Electro-magnets pull them.

The computerized controller shuts down the Electro-magnets, then reverses them to perpetuate the rotary motion.

The side view shows the placement of the fixed Electro-magnets and a moment in time of the magnetic forces in play. At this moment there are twenty-four magnetic forces driving the permanent magnet array in a counter clockwise motion.

The Electro-magnet details simply shows both the empty core and the core filled with wire.

### ALTERNATE DRAWING DESCRIPTION

These drawings show an alternate arrangement of the rotating permanent magnet assembly. This method requires horseshoe shaped permanent magnets. They are arranged with alternating polarity the same as the other version. This allows the same push pull effect. The multiple Electro-magnets are still individually controlled as before utilizing all the available magnetic fields. The controller would still be very similar.

### DETAILED DESCRIPTION OF INVENTION PG1

The basic idea behind this motor is the use of an array of permanent magnets pushed and pulled around by an array of Electro-magnets. The number of permanent magnets on each side of the rotor must consist of an even number of magnets, (see side view drawing). The outer perimeter clearly shows the polarity to be north, south, north, south etc.. The total number of magnets in the array would have to be a multiple of four. This example shows eight (two sets of four).

The number of Electro-magnets shown in this example is twelve, three in each space between permanent magnets. I will refer to them as follows: there are two Electro-magnets in the outer perimeter of each section. One is repelling the same polarity it is while the one next to it, in a clockwise manner, is pulling its counter polarity. The Electro-magnets in the inner perimeter are pushing and pulling at the same time. The space between the permanent magnets is mush less toward the center.

### DETAILED DESCRIPTION OF INVENTION PG2

This magnetic array is also possible with horseshoe shaped permanent or Electro-magnets. I chose this configuration because it was easier to obtain parts to build a small-scale model.

Not shown in the drawings are the sensors necessary to tell the controller which Electro-magnets to activate, and when. Many types of sensors are available. It will take testing to determine which type will work properly in the different applications of this motor.

The controller will function based on the demands set on it by the amount of depression on the accelerator control and the current speed. The further down the accelerator pedal is pressed and the slower the speed will signal the controller to activate more Electro-magnets.

Since there is no “idle” speed for the motor, the first several degrees of depression of the accelerator will activate only a minimum number of Electro-magnets for both forward and reverse. Reverse will also be governed to have a slow speed only.

### DETAILED DESCRIPTION OF INVENTION PG3

The motor controller is comprised of a computer controlling solid state switches. In the example of the motor illustrated in the drawings there would be twenty-four switching devices in all. The center of a center tapped power source would be connected to one side of all the Electro-magnets while the other connection to the Electro-magnets would be alternated between the two opposite ends of the power source by the electronic switches.

As the whirling magnet approaches the Electro-magnet pulling it, the power to that Electro-magnet is switched off. As soon as it passes the center of that magnetic field the Electro-magnets voltage is reversed and pushes the permanent magnet back away.

### SPECIFICATION

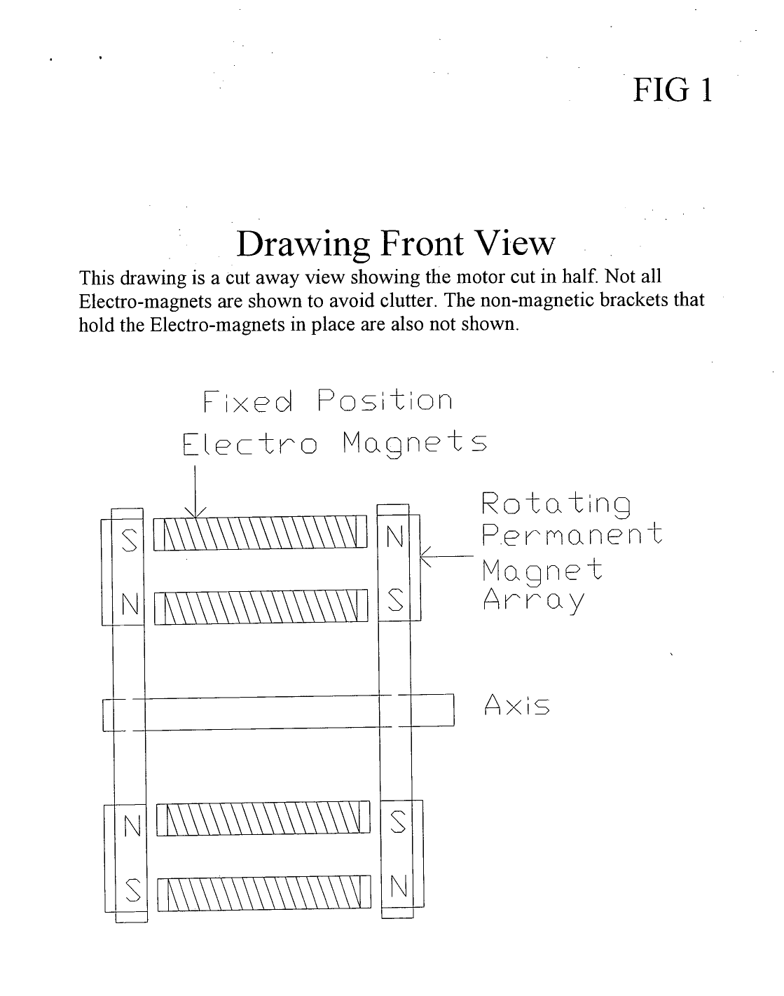

The logic behind this electric motor is the use of an array of rotating permanent magnets (FIG. 1) powered by individually pulsed Electro-magnets pushing and or pulling the magnet armature in a rotational motion.

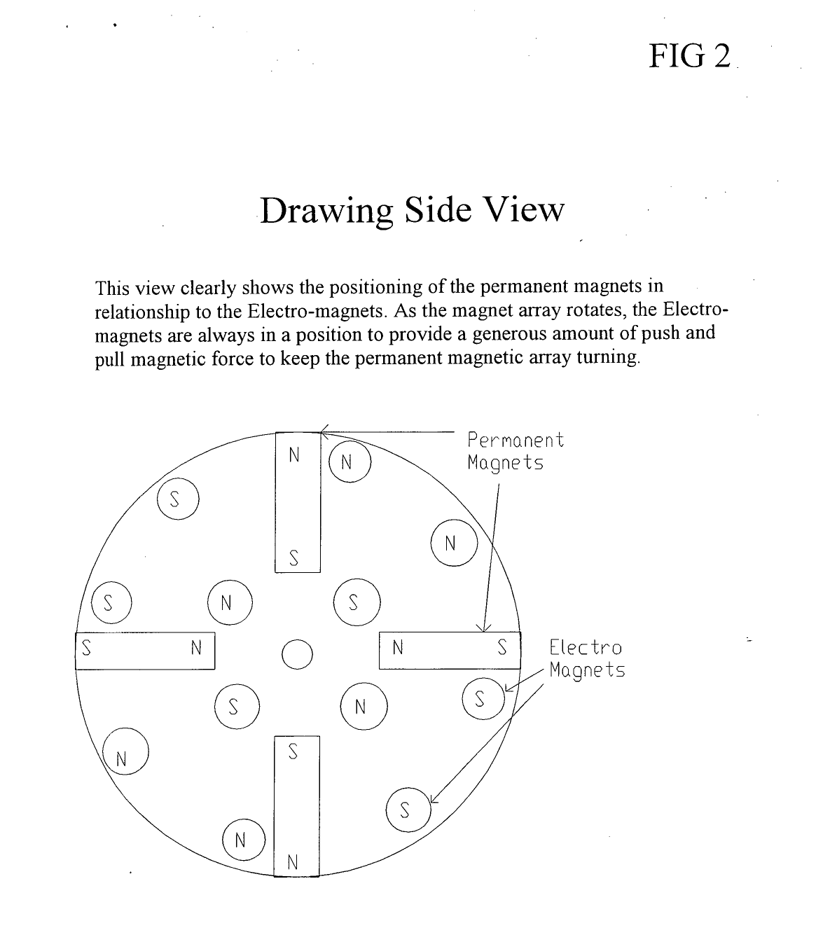

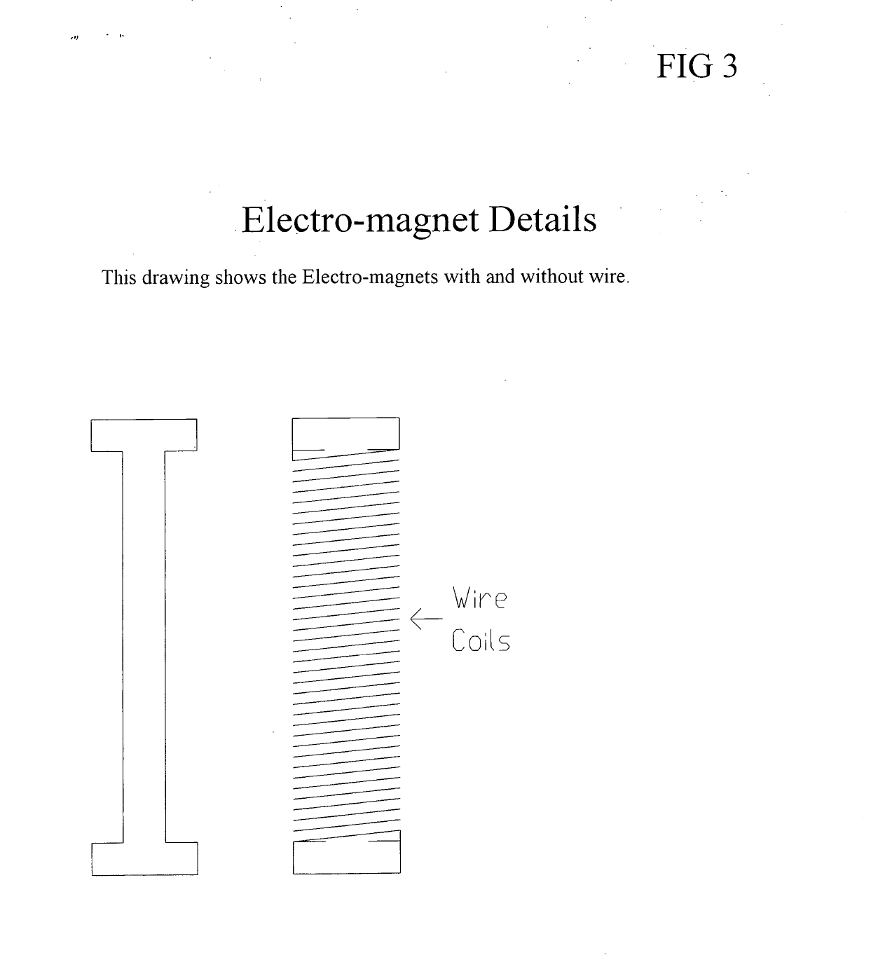

The rotating permanent magnet array (FIG. 2) is structured such that both the north and south magnetic fields are used to provide rotary torque. Both fields of the Electro-magnets ( FIG. 3) are utilized also.

A computer controlled alternating direct current pulse (sine wave) generator provides the digital control for this motor. The frequency and duration of the pulses control the rotational speed. The voltage and number of Electro-magnets activated control the power (torque).

Each Electro-magnet has it's own controller circuit. The direct current applied to the Electro-magnet is turned off as the permanent magnet nears it. The polarity of the voltage applied to the Electro-magnet is reversed after the rotating permanent magnet passes its center.

### DESCRIPTION OF DRAWINGS

The front view (FIG. 1) drawing is a cutaway view showing the motor cut in half. It plainly shows four of the eight permanent magnets in this smaller example. As you can see the permanent magnets are opposed in respect to polarity. The pairs of Electro-magnets are energized such that south pushes south and north pushes north. The next set of permanent magnets in the rotating array are opposite in polarity such that the Electro-magnets pull them.

The computerized controller shuts down the Electro-magnets, then reverses them to perpetuate the rotary motion.

The side view (FIG. 2) shows the placement of the fixed Electro- magnets and a moment in time of the magnetic forces in play. At this moment there are twenty-four magnetic forces driving the permanent magnet array in a counter clockwise motion.

The Electro-magnet details (FIG. 3) simply shows both the empty core and the core filled with wire.

1. The high torque at low RPM eliminates the need for a torque converter (transmission) for low speed control applications.

2. The use of multiple Electro-magnets allows the controller to turn off some of the magnets to reduce power instead of lowering the voltage. This keeps the efficiency higher and alternating which Electro-magnets gets energized helps disperse the heat better.

3. Another benefit of the multiple Electromagnets and their separate controller circuits is dependability. Should any of the controller circuits or the Electro-magnets fail, the rest of the Electro-magnets and circuits continue to function with only minimal extra stress at reduced power.
